(19) United States
(12) Patent Application Publication
(10) Pub. No.: US 2008/0002300 A1
(43) Pub. Date: Jan. 3, 2008

(54) Head, head suspension assembly, and disk device provided with the same

(75) Inventor: Mitsunobu Hanyu, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/819,046

(22) Filed: Jun. 25, 2007

(30) Foreign Application Priority Data
Jun. 30, 2006 (JP) 2006-182691

(51) Int. Cl. G11B 5/60

(52) U.S. Cl. 360/235.7

(57) ABSTRACT

According to one embodiment, a slider of a head has a negative-pressure cavity formed in a facing surface, a leading step portion which protrudes from the facing surface and is situated on an upstream side of the negative-pressure cavity with respect to an airflow, a trailing step portion which protrudes from the facing surface and is situated on a downstream side of the negative-pressure cavity with respect to the airflow, and a trailing pad which protrudes from the trailing step portion. The trailing pad has a base portion provided on the trailing step portion and situated on the outflow end side of the slider, a pair of wing portions extending from the base portion to opposite sides in a second direction, and two extending portions which individually extend from the base portion to the upstream side of the airflow and define a recess which opens toward the negative-pressure cavity.

### CROSS-REFERENCE TO RELATED APPLICATIONS

This application is based upon and claims the benefit of priority from Japanese Patent Application No. 2006-182691, filed Jun. 30, 2006, the entire contents of which are incorporated herein by reference.

### BACKGROUND

1. Field

One embodiment of the invention relates to a head used in a disk device such as a magnetic disk device, a head suspension assembly provided with the head, and a disk device provided with the head suspension assembly.

2. Description of the Related Art

A disk device, e.g., a magnetic disk device, comprises a magnetic disk, spindle motor, magnetic head, and carriage assembly. The magnetic disk is disposed in a case. The spindle motor supports and rotates the disk. The magnetic head writes and reads information to and from the disk. The carriage assembly supports the magnetic head for movement with respect to the magnetic disk. The carriage assembly comprises a rockably supported arm and a suspension extending from the arm. The magnetic head is supported on an extended end of the suspension. The head has a slider attached to the suspension and a head portion on the slider. The head portion is constructed including a reproducing element for reading and a recording element for writing.

The slider has a facing surface that is opposed to a recording surface of the magnetic disk. A predetermined head load directed to a magnetic recording layer of the disk is applied to the slider by the suspension. When the magnetic disk device is actuated, an airflow is generated between the disk in rotation and the slider. Based on the principle of aerodynamic lubrication, a force to fly the slider above the recording surface of the disk acts on the facing surface of the slider. By balancing this flying force with the head load, the slider is flown with a given gap above the recording surface of the disk.

The flying height of the slider is expected to be substantially fixed without regard to the radial position of the magnetic disk. The rotational frequency of the disk is constant, while its peripheral speed varies depending on the radial position. Since the magnetic head is positioned by the rotary carriage assembly, moreover, a skew angle (angle between the direction of the flow and the center line of the slider) also varies depending on the radial position of the disk. In designing the slider, therefore, change of the flying height based on the radial position of the disk must be suppressed by suitably utilizing the aforesaid two parameters that vary depending on the radial position of the disk.

In consideration of change of the working environment, the disk device is expected to operate smoothly even in a highland area in a low-pressure environment. If the magnetic head is constructed in consideration of only the balance between the head load and a positive pressure that is exerted on the facing surface of the slider by aerodynamic lubrication, the positive pressure caused by the lubrication lowers. Inevitably, therefore, the slider may be balanced in a position where the flying height is lowered or be brought into contact with the surface of the magnetic disk.

As described in Jpn. Pat. Appln. KOKAI Publication No. 2001-283549, for example, there is known a disk device in which a negative-pressure cavity is formed near the center of the facing surface of the slider in order to prevent such lowering of the flying height. The negative-pressure cavity is formed of a groove that is surrounded by projecting rails in three other directions than an air outflow direction. The slider is configured to fly when the head load, the positive pressure, and a negative pressure generated by the negative-pressure cavity are balanced. According to this configuration, a slider can be realized such that the flying height lowers little in a low-pressure environment, since the negative pressure lowers together with the positive pressure. On the air outflow end side of the slider, moreover, a center pad is formed in the negative-pressure cavity, and the head portion is provided on the outflow end face of the slider near the center pad.

Thus, the flying height, flying posture, and low-pressure flying height of the slider can be adjusted by devising the shape of the irregular facing surface of the slider. The irregular shape of the facing surface of the slider is formed of grooves of a single depth or several different depths.

When the disk device constructed in this manner is actuated, the magnetic head performs seek operation such that it moves on the surface of the magnetic disk from (or to) its outer peripheral side to (or from) its inner outer peripheral side toward a desired track. With the recent trend toward higher-speed processing, the seek speed of the magnetic head has been made higher and higher.

During the seek operation of the magnetic head, however, an air film force that is generated between the magnetic disk surface and the slider varies, so that the flying height of the slider fluctuates. As the seek speed increases, in particular, the air film force is reduced, and the flying height of the slider lowers. If the flying behavior of the magnetic head changes in this manner, recording and reproduction may possibly fail to be stabilized. Thus, the device lacks in reliability.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view showing an HDD according to an embodiment of the invention;

FIG. 2 is an exemplary enlarged side view showing a magnetic head portion of the HDD;

FIG. 3 is an exemplary perspective view showing the disk-facing surface side of a slider of the magnetic head;

FIG. 4 is an exemplary plan view showing the disk-facing surface side of the slider;

FIG. 5 is an exemplary sectional view taken along line A-A of FIG. 4;

FIG. 6 is an exemplary diagram showing variations in air film force attributable to seek speed change with respect to the magnetic head according to the present embodiment and a magnetic head according to Comparative Example;

FIGS. 7A, 7B, 7C, 7D and 7E are exemplary plan views showing five types of magnetic head sliders having trailing pads of different shapes;

FIG. 8 is an exemplary diagram showing ratios for the five types of magnetic head sliders between the respective lengths of extending portions of the trailing pads;

FIG. 9 is an exemplary diagram showing variations in air film force attributable to seek speed change with respect to the five types of magnetic heads;

FIG. 10 is an exemplary plan view typically showing relative positions of airflows with yaw angles, a trailing step portion, and a trailing pad;

FIG. 11 is an exemplary diagram showing results of an analysis of variations in air film force attributable to seek speed change with respect to the five types of magnetic head sliders, observed when the depth of the trailing step portion is changed;

FIG. 12 is an exemplary diagram showing results of an analysis of variations in air film force attributable to seek speed change with respect to the five types of magnetic head sliders, observed when the depth of a negative-pressure cavity is changed;

FIG. 13 is an exemplary diagram comparatively showing variations in flying height attributable to change of the speed of seek (from (or to) the inner peripheral side to (or from) the outer peripheral side of a disk), with respect to the magnetic heads according to Example 1 and Comparative Example;

FIG. 14 is an exemplary diagram showing slider flying heights in peripheral positions (inner, intermediate, and outer) on the disk and flying height profiles obtained during high-speed seek operation (with the ratio of seek speed to disk speed at 1.0), with respect to the magnetic head according to Comparative Example;

FIG. 15 is an exemplary diagram showing slider flying heights in the peripheral positions (inner, intermediate, and outer) on the disk and flying height profiles obtained during high-speed seek operation (with the ratio of seek speed to disk speed at 1.0), with respect to the magnetic head according to Example 1; and

FIG. 16 is an exemplary plan view typically showing a magnetic head slider of an HDD according to another embodiment of the invention.

### DETAILED DESCRIPTION

Various embodiments according to the invention will be described hereinafter with reference to the accompanying drawings. In general, according to one embodiment of the invention, there is provided a head comprising: a slider which has a facing surface opposed to a surface of a rotatable recording medium and is flown by an airflow which is generated between the recording medium surface and the facing surface as the recording medium rotates; and a head portion which is disposed on the slider and records and reproduces information to and from the recording medium. The slider has a negative-pressure cavity which is defined by a recess formed in the facing surface and generates a negative pressure, a leading step portion which protrudes from the facing surface, is situated on the upstream side of the negative-pressure cavity with respect to the airflow, and faces the recording medium, a trailing step portion which protrudes from the facing surface, is situated on the downstream side of the negative-pressure cavity with respect to the airflow, and faces the recording medium, and a trailing pad which protrudes from the trailing step portion. The facing surface of the slider has a first direction extending in the direction of the airflow and a second direction perpendicular to the first direction, and the trailing pad has a base portion provided on the trailing step portion and situated on the outflow end side of the slider, a pair of wing portions extending from the base portion to opposite sides in the second direction, and two extending portions which individually extend from the base portion to the upstream side of the airflow and define a recess which opens toward the negative-pressure cavity.

A disk device according to another aspect of the invention comprises: a disk-shaped recording medium; a drive section which supports and rotates the recording medium; a head which includes a slider which has a facing surface opposed to a surface of the recording medium and is flown by an airflow which is generated between the recording medium surface and the facing surface as the recording medium rotates and a head portion which is disposed on the slider and records and reproduces information to and from the recording medium; and a head suspension which supports the head for movement with respect to the recording medium and applies a head load directed to a surface of the recording medium to the head. The slider has a negative-pressure cavity which is defined by a recess formed in the facing surface and generates a negative pressure, a leading step portion which protrudes from the facing surface, is situated on the upstream side of the negative-pressure cavity with respect to the airflow, and faces the recording medium, a trailing step portion which protrudes from the facing surface, is situated on the downstream side of the negative-pressure cavity with respect to the airflow, and faces the recording medium, and a trailing pad which protrudes from the trailing step portion. The facing surface of the slider has a first direction extending in the direction of the airflow and a second direction perpendicular to the first direction, and the trailing pad has a base portion provided on the trailing step portion and situated on the outflow end side of the slider, a pair of wing portions extending from the base portion to opposite sides in the second direction, and two extending portions which individually extend from the base portion to the upstream side of the airflow and define a recess which opens toward the negative-pressure cavity.

An embodiment in which a disk device according to this invention is applied to a hard disk drive (HDD) will now be described in detail with reference to the accompanying drawings.

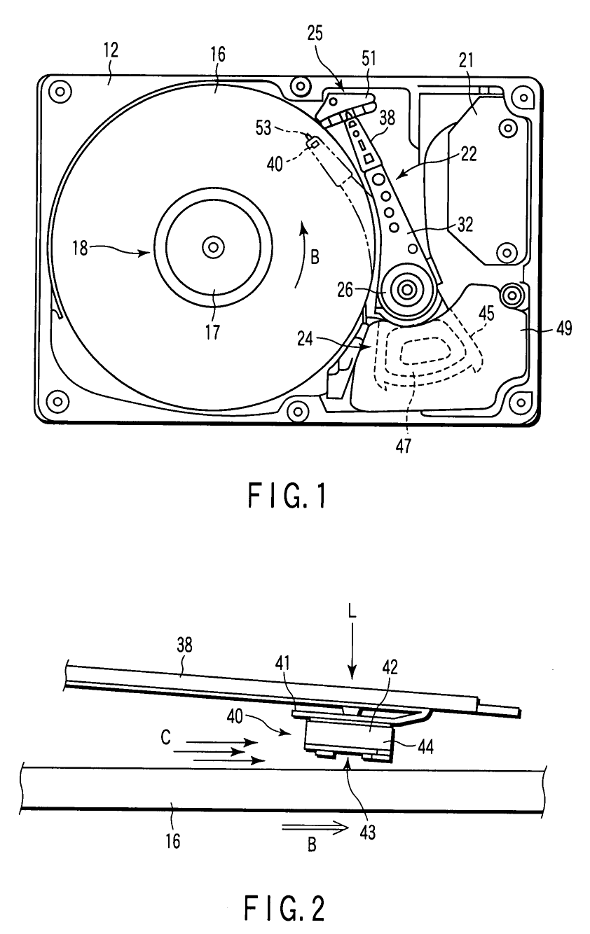

As shown in FIG. 1, the HDD has a case 12 in the form of an open-topped rectangular box and a top cover (not shown). The top cover is fastened to the case by screws so as to close a top opening of the case.

The case 12 contains a magnetic disk 16, spindle motor 18, magnetic heads 40, carriage assembly 22, voice coil motor (VCM) 24, ramp load mechanism 25, board unit 21, etc. The magnetic disk 16 serves as a recording medium. The spindle motor 18 serves as a drive section that supports and rotates the magnetic disk. The magnetic heads write and read information to and from the disk. The carriage assembly 22 supports the magnetic heads for movement with respect to the magnetic disk 16. The VCM 24 rocks and positions the carriage assembly. The ramp load mechanism 25 holds the magnetic heads in a retracted position at a distance from the magnetic disk when the heads are moved to the outermost periphery of the disk. The board unit 21 has a head IC and the like.

A printed circuit board (not shown) for controlling the operations of the spindle motor 18, VCM 24, and magnetic heads through the board unit 21 is screwed to the outer surface of a bottom wall of the case 12.

The magnetic disk 16 has magnetic recording layers on its upper and lower surfaces, individually. The disk 16 is fitted on a hub (not shown) of the spindle motor 18 and fixed on the hub by a clamp spring 17. If the motor 18 is actuated, the disk 16 is rotated at a predetermined speed of, for example, 4,200 rpm in the direction of arrow B.

The carriage assembly 22 is provided with a bearing portion 26 fixed on the bottom wall of the case 12 and arms 32 extending from the bearing portion. The arms 32 are situated parallel to the surfaces of the magnetic disk 16 and spaced from one another. They extend in the same direction from the bearing portion 26. The carriage assembly 22 is provided with suspensions 38 that are elastically deformable elongate plates. Each suspension 38 is formed of a leaf spring, of which the proximal end is fixed to the distal end of its corresponding arm 32 by welding or adhesive bonding and which extends from the arm. Alternatively, each suspension may be formed integrally with its corresponding arm 32. The arm 32 and the suspension 38 constitute a head suspension, and the head suspension and the magnetic heads 40 constitute a head suspension assembly.

As shown in FIG. 2, each magnetic head 40 has a slider 42 substantially in the shape of a rectangular parallelepiped and a recording/reproducing head portion 44 on the slider. It is fixed to a gimbals spring 41 that is provided on the distal end portion of each suspension 38. Each magnetic head 40 is subjected to a head load L directed to a surface of the magnetic disk 16 by the elasticity of the suspension 38.

As shown in FIG. 1, the carriage assembly 22 has a support frame 45 extending from the bearing portion 26 in the direction opposite from the arms 32. The support frame supports a voice coil 47 that constitutes a part of the VCM 24. The support frame 45 is molded from plastic and formed integrally on the outer periphery of the voice coil 47. The voice coil 47 is situated between a pair of yokes 49 that are fixed on the case 12 and, in conjunction with these yokes and a magnet (not shown) fixed to one of the yokes, constitutes the VCM 24. If the voice coil 47 is energized, the carriage assembly 22 rocks around the bearing portion 26, whereupon each magnetic head 40 is moved to and positioned in a region over a desired track of the magnetic disk 16.

The ramp load mechanism 25 comprises a ramp 51 and tabs 53. The ramp 51 is provided on the bottom wall of the case 12 and located outside the magnetic disk 16. The tabs 53 extend individually from the respective distal ends of the suspensions 38. As the carriage assembly 22 rocks to its retracted position outside the magnetic disk 16, each tab 53 engages a ramp surface on the ramp 51 and is then pulled up along the slope of the ramp surface, whereupon each magnetic head is unloaded.

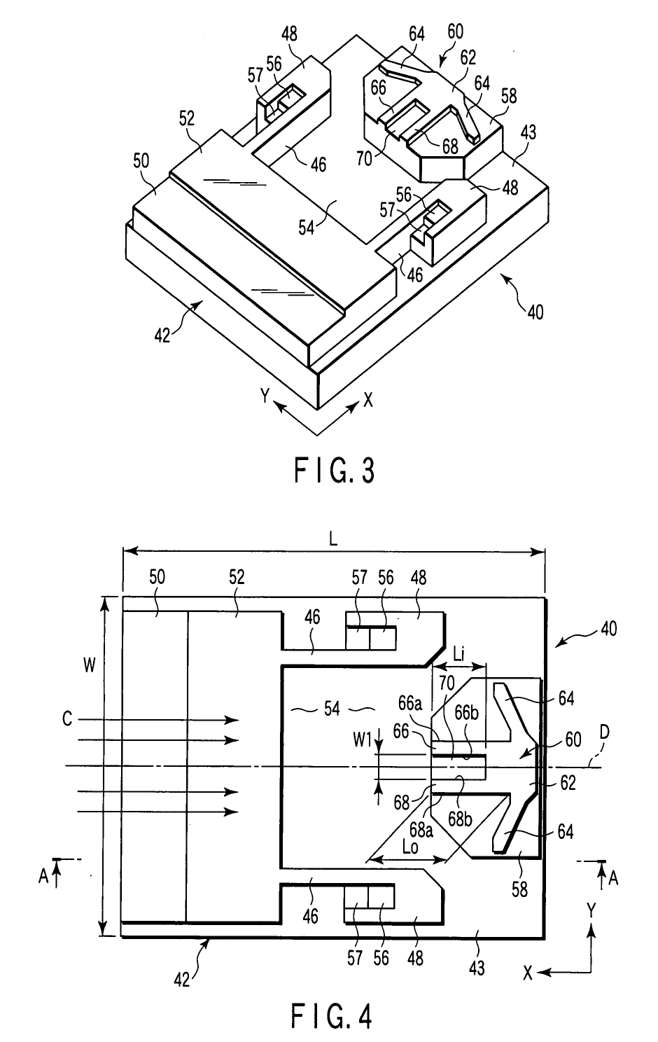

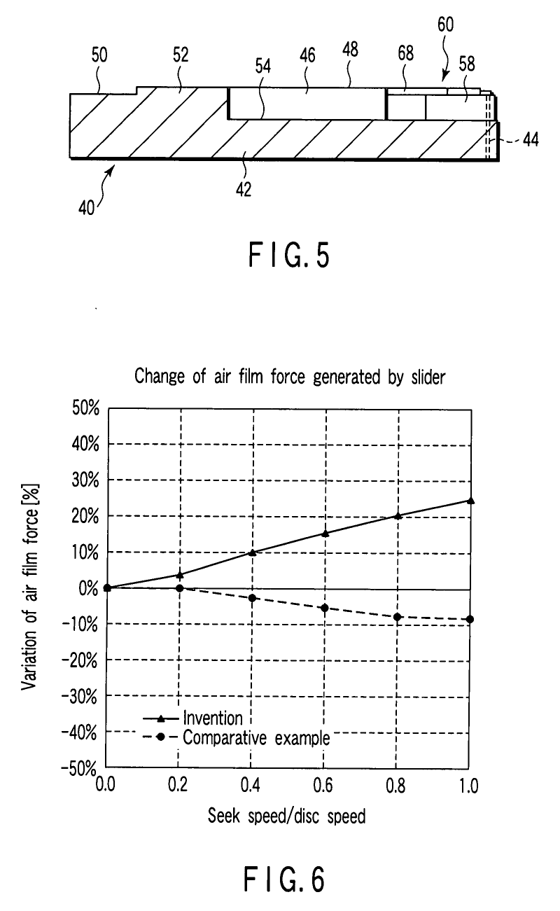

The following is a detailed description of each magnetic head 40. FIG. 3 is perspective view showing the slider of the magnetic head, FIG. 4 is a plan view of the slider, and FIG. 5 is a sectional view of the slider.

As shown in FIGS. 3 to 5, the magnetic head 40 has the slider 42 that is substantially in the shape of a rectangular parallelepiped. The slider 42 has a rectangular disk-facing surface (air bearing surface (ABS)) 43, which faces a surface of the magnetic disk 16. The longitudinal direction of the disk-facing surface 43 is supposed to be a first direction X, and the transverse direction perpendicular thereto to be a second direction Y. The disk-facing surface 43 has a central axis D that extends in the first direction X.

The slider 42 is formed as a so-called femto slider, having a length L of 1.25 mm or less, e.g., 0.85 mm, in the first direction X and a width W of 1.0 mm or less, e.g., 0.7 mm, in the second direction Y.

The magnetic head 40 is constructed as a flying head, in which the slider 42 is flown by an airflow C (see FIG. 2) that is generated between the disk surface and the disk-facing surface 43 as the magnetic disk 16 rotates. When the HDD is operating, the disk-facing surface 43 of the slider 42 never fails to be opposed to the disk surface with a gap therebetween. The direction of the airflow C is coincident with the rotation direction B of the magnetic disk 16. The slider 42 is located so that the first direction X of the disk-facing surface 43 opposed to the surface of the disk 16 is substantially coincident with the direction of the airflow C.

A substantially rectangular leading step portion 50 protrudes from the disk-facing surface 43 so as to face the magnetic disk surface. The leading step portion 50 is formed covering the upstream-side portion of the disk-facing surface 43 with respect to the direction of the airflow C. A pair of side portions 46 protrudes from the disk-facing surface 43. They extend along the long sides of the surface 43 and are opposed to each other with a space between them. The side portions 46 extend from the leading step portion 50 toward the downstream end of the slider 42. The leading step portion 50 and the pair of side portions 46 are located symmetrically with respect to the central axis D of the slider 42. As a whole, they are formed substantially in the shape of a U, closed on the upstream side and open to the downstream side.

In order to maintain the pitch angle of the magnetic head 40, a leading pad 52 that utilizes an air film to support the slider 42 protrudes from the leading step portion 50. The leading pad 52 continuously extends throughout the area in the width direction of the leading step portion 50 in the second direction Y, and is formed in a position deviated on the downstream side from the inflow end of the slider 42. The leading pad 52 is situated on the inflow end side of the slider 42 with respect to the direction of the airflow C. A side pad 48 is formed on each side portion 46 and leads to the leading pad 52. The pads 52 and 48 are formed substantially flat and face the magnetic disk surface.

Recesses 56 and 57 are formed in each side pad 48. The recesses 56 and 57 open toward the inflow end of the disk-facing surface 43 as well as toward the magnetic disk surface. The recesses 56 and 57 have a rectangular shape defined by a pair of side edges, which extend substantially parallel to the first direction X, and a bottom edge, which connects the respective extended ends of the side edges and extends substantially parallel to the second direction Y.

As shown in FIGS. 3 and 4, a negative-pressure cavity 54 is formed substantially in the center of the disk-facing surface 43. It is a recess that is defined by the pair of side portions 46, the leading pad 52, the side pads 48, and a trailing step portion 58. The cavity 54 is formed on the downstream side of the leading pad 52 with respect to the direction of the airflow C and opens toward the downstream side. The negative-pressure cavity 54 serves to produce a negative pressure on the central part of the disk-facing surface 43 at all feasible yaw angles for the HDD.

The slider 42 has the trailing step portion 58 that protrudes from the downstream end portion of the disk-facing surface 43 and faces the magnetic disk surface. The trailing step portion 58 is situated in the downstream side of the negative-pressure cavity 54 with respect to the direction of the airflow C and substantially in the center of the disk-facing surface 43 with respect to the second direction Y.

As shown in FIGS. 3 to 5, the trailing step portion 58 is substantially in the shape of a rectangular parallelepiped, of which two corner portions on the upstream side are chamfered. The height of projection (or depth) of the trailing step portion 58 is equal to that of the leading step portion 50 and the recess 56.

A trailing pad 60 that utilizes an air film to support the slider 42 protrudes from the trailing step portion 58. The trailing pad 60 is formed a little higher than the upper surface of the trailing step portion 58 and flush with the leading pad 52 and the side pads 48.

The trailing pad 60 has a substantially rectangular base portion 62, a pair of wing portions 64 extending from the base portion to opposite sides in the second direction, and two extending portions 66 and 68 individually extending from the base portion toward the upstream end of the slider.

In the trailing step portion, the base portion 62 is provided on the central axis D on the outflow end side and situated substantially in the center with respect to the second direction Y. Each wing portion 64 extends in the second direction Y from the base portion 62 and with a small inclination toward the upstream end.

The two extending portions 66 and 68 individually extend in the first direction X and face each other with a gap between them. The extending portions 66 and 68 and the base portion 62 define a substantially rectangular recess 70 that opens toward the negative-pressure cavity 54. In the present embodiment, the two extending portions 66 and 68 are equal in length in the first direction X and extend up to the upstream end edge of the trailing step portion 58.

The extending portion 66 has an outside edge 66a and an inside edge 66b that individually extend in the first direction. The outside edge 66a extends continuously with a side edge of the base portion 62. The inside edge 66b extends from the upstream end edge of the base portion 62 that extends in the second direction Y. Likewise, the extending portion 68 has an outside edge 68a and an inside edge 68b that individually extend in the first direction. The outside edge 68a extends continuously with a side edge of the base portion 62. The inside edge 68b extends from the upstream end edge of the base portion 62 and faces the inside edge 66b of the extending portion 66 in parallel relation with a gap therebetween.

The outside edges 66a and 68a and the inside edges 66b and 68b of the extending portions 66 and 68 and the upstream end edge of the base portion 62 rise substantially at right angles from the trailing step portion 58. The recess 70 is defined by the inside edges 66b and 68b of the extending portions 66 and 68 and the upstream end edge of the base portion 62.

If the lengths of the outside edges 66a and 68a and the inside edges 66b and 68b in the first direction X are Lo and Li, respectively, Lo and Li each account for 10% or more of the length L of the slider 42 in the first direction X. A space W1 between the extending portions 66 and 68 in the second direction Y, i.e., the space between the inside edges 66b and 68b in this case, accounts for 10% or more of the width W of the slider 42 in the second direction Y.

As shown in FIGS. 3 to 5, the head portion 44 of the magnetic head 40 has a recording element and a reproducing element, which record and reproduce information to and from the magnetic disk 16. The reproducing and recording elements are embedded in the downstream end portion of the slider 42 with respect to the direction of the airflow C. The reproducing and recording elements have a read/write gap (not shown) that is defined in the trailing pad 60.

According to the HDD and the head suspension assembly constructed in this manner, the magnetic head 40 is flown by the airflow C that is generated between the disk surface and the disk-facing surface 43 as the magnetic disk 16 rotates. When the HDD is operating, therefore, the disk-facing surface 43 of the slider 42 never fails to be opposed to the disk surface with a gap therebetween. As shown in FIG. 2, the magnetic head 40 flies in an inclined posture such that the read/write gap of the head portion 44 is located closest to the disk surface.

According to the magnetic head 40 constructed in this manner, the trailing pad 60 has the two extending portions 66 and 68 that extend from the base portion 62 toward the upstream end or inflow end side of the slider 42, the extending portions defining the recess 70. Thus, even in high-speed seek operation, variation of the flying height of the magnetic head 40 can be suppressed to improve stability and reliability.

Variation of the force of the air film was simulated with the seek speed of the magnetic head 40 changed. If the ratio of the seek speed to the rotational speed of the disk reaches 1.0, in a magnetic head (Comparative Example) in which the trailing pad 60 is not provided with the extending portions 66 and 68, the air film force that is generated in a predetermined flying posture inevitably lowers by 8%, as indicated by broken line in FIG. 6. In the magnetic head 40 according to the present embodiment, on the other hand, if the ratio of the seek speed to the rotational speed of the disk reaches 1.0, the air film force increases by 25%, as indicated by solid line in FIG. 6, thus exhibiting a considerable improvement.

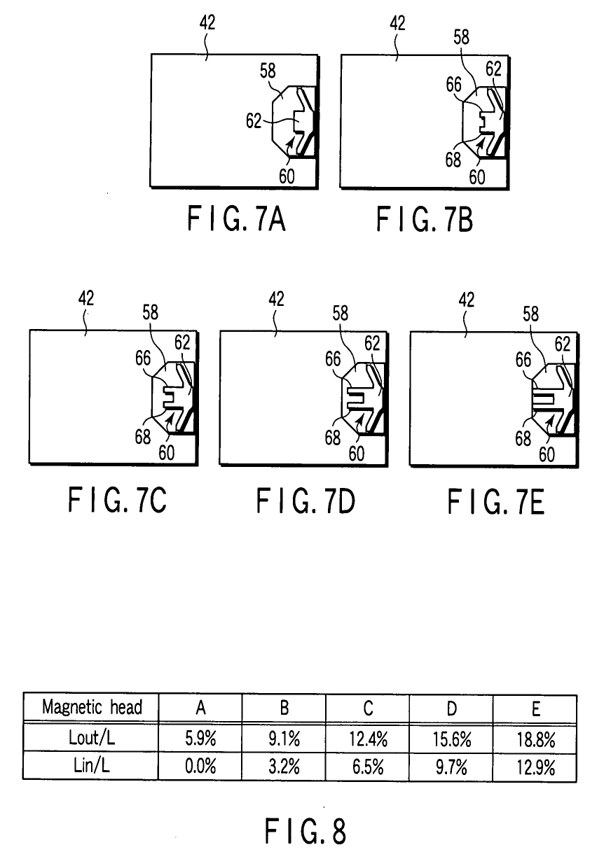

In order to analyze the reason for the improvement of the air film force, the inventors hereof prepared magnetic heads that have various trailing pads of different shapes, e.g., five types of magnetic heads A, B, C, D and E, as shown in FIGS. 7A, 7B, 7C, 7D and 7E, and compared them for variations of the air film force caused by increase in the seek speed. All the five magnetic heads share in common the area of the trailing step portion 58 of the slider, the height of projection (or depth) of the trailing step portion, and the depth of the negative-pressure cavity. They are different only in the shape of the trailing pad 60. By way of example, the depths of the negative-pressure cavity and the trailing step portion were set to 1.2 μm and 0.08 μm, respectively.

The trailing pad 60 of the magnetic head A has no extending portion. The magnetic heads B, C, D and E, like the magnetic head according to the present embodiment, are all configured so that the trailing pad 60 has two extending portions and are different in the length of the extending portions.

FIG. 8 shows ratios for the individual magnetic heads between a length Lout of the respective outside edges of the extending portions 66 and 68 (including the side edges of the base portion 62 in this case) and the length L of the slider 42 in the first direction X and between a length Lin of the respective inside edges of the extending portions and the length L of the slider 42 in the first direction X.

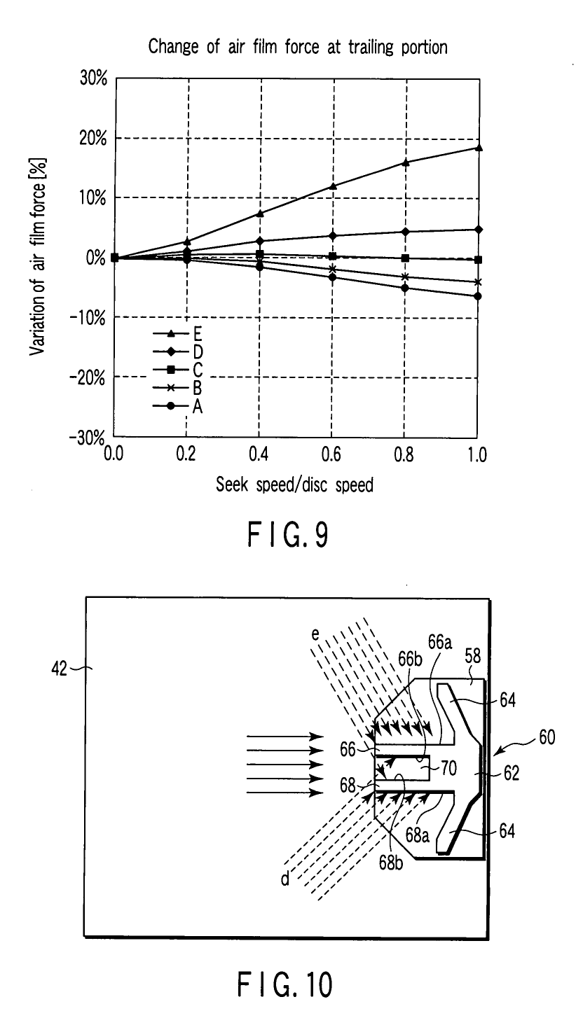

For the magnetic heads A, B, C, D and E, variation of the air film force at the trailing step portion was simulated with the seek speed changed. FIG. 9 shows results of this simulation. In the cases of the magnetic head A having no extending portion and the magnetic head B with short extending portions, as seen from FIG. 9, the air film force gradually decreases if the seek speed increases.

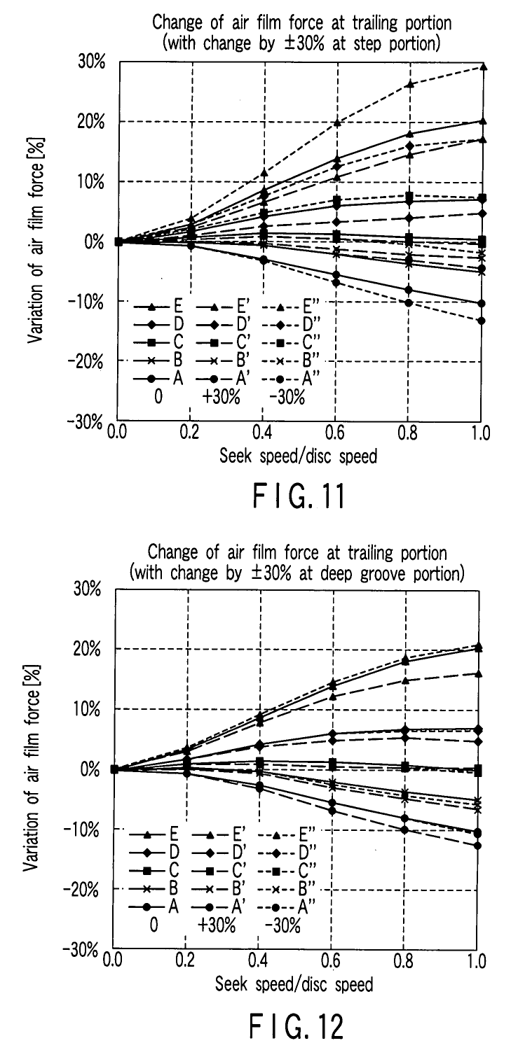

If the length of the extending portions 66 and 68 is increased, as in the cases of the magnetic heads C, D and E, the air film force is found rather to increase as the seek speed increases. In the magnetic head E with the extending portion length ratio Lout/L of 18.8%, if the ratio of the seek speed to the rotational speed of the disk reaches 1.0, the air film force increases by less than 20%, thus exhibiting a considerable improvement. This is because the air film force is generated when airflows d and e with yaw angles are received by the outside edges 66a and 68a and the inside edges 66b and 68b of the extending portions 66 and 68 after they are received by the trailing step portion 58 during seeking operation, as shown in FIG. 10.

Thus, an effect can be obtained to suppress the reduction of the air film force during seek operation by adjusting the ratio (Lout/L) of the length of the extending portions 66 and 68, i.e., the length of outside edges, to the length L of the slider in the first direction X to 10% or more.

If the depth of the negative-pressure cavity or the trailing step portion of the slider in each of the magnetic heads A to E is increased or reduced, as seen from FIGS. 11 and 12, the effect to suppress the reduction of the air film force during seek operation can be maintained according to the magnetic heads C, D and E.

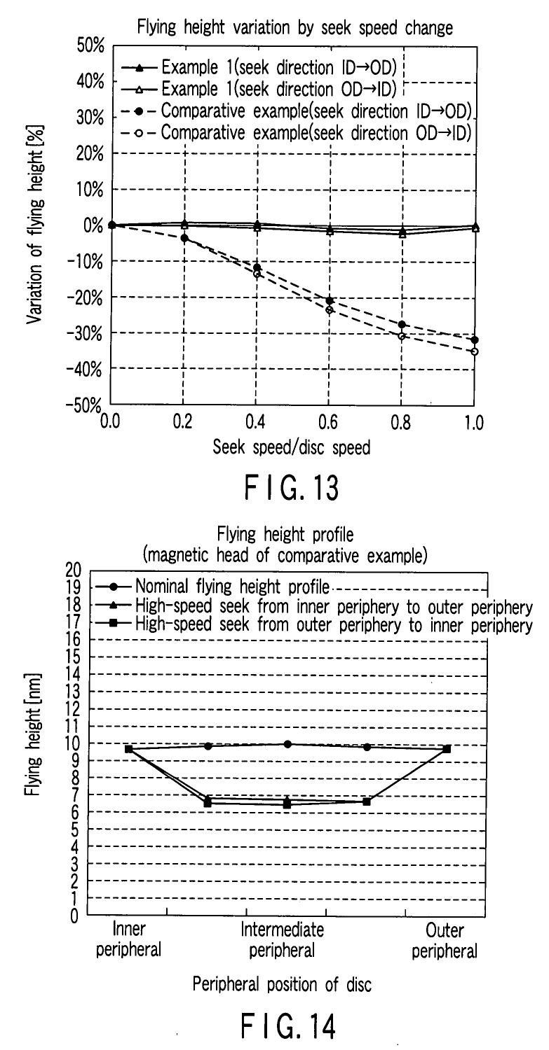

FIG. 13 shows results of simulation of changes of the flying height during seek operation for the magnetic head according to the present embodiment (Example 1) and the magnetic head (Comparative Example) of which the trailing pad has no extending portion. In FIG. 13, the abscissa axis represents the ratio of the seek speed to the rotational speed of the disk. The magnetic heads of Example 1 and Comparative Example are different only in the shape of the trailing pad, and share in common the configurations of the leading step portion and the side portions, the depth of the negative-pressure cavity, and the depth of the step portions. In moving each magnetic head for seeking from the inner peripheral portion (ID) to the outer peripheral portion (OD) of the magnetic disk and from the OD to the ID, the magnetic head according to the present embodiment (Example 1) is hardly subject to any variation in flying height attributable to seek speed change, thus exhibiting a considerable improvement as compared with the prior art example.

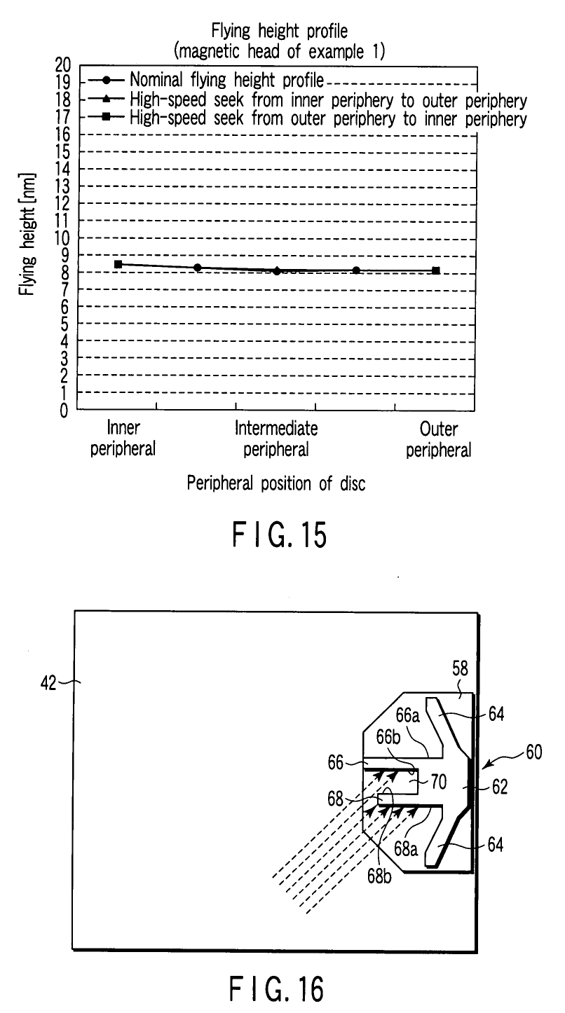

Further, the magnetic heads of Comparative Example and Example 1 were analyzed for flying height profiles obtained during high-speed seek operation (with the ratio of seek speed to disk speed at 1.0). As seen from FIG. 14, the flying height of the magnetic head of Comparative Example varies considerably. As seen from FIG. 15, on the other hand, the magnetic head of Example 1 flies lower than the magnetic head of Comparative Example, and the variation of its flying height during high-speed seek operation is reduced considerably.

Thus, according to the magnetic head of the present embodiment and the head suspension assembly and the HDD provided with the same, the reduction of the air film force generated by the slider can be suppressed even during high-speed seek operation, so that the variation of the flying height can be suppressed to improve stability and reliability.

While certain embodiments of the invention have been described, these embodiments have been presented by way of example only, and are not intended to limit the scope of the invention. Indeed, the novel methods and systems described herein may be embodied in a variety of forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

The shapes, dimensions, etc. of the leading step portion, trailing step portion, and pads of the slider are not limited to the embodiment described herein but may be varied as required. As shown in FIG. 16, for example, the extending portions 66 and 68 of the trailing pad 60 need not always be equal in length, but may be formed having different lengths within a range that meets the aforementioned conditions. Further, the inside and outside edges of the extending portions are not limited to the straight shape but may alternatively be curved.

This invention is not limited to femto sliders but may be also applied to pico sliders, pemto sliders, or any other larger sliders.

What is claimed is:

1. A head comprising:
a slider which has a facing surface opposed to a surface of a rotatable recording medium and is flown by an airflow which is generated between the recording medium surface and the facing surface as the recording medium rotates; and
a head portion which is disposed on the slider and records and reproduces information to and from the recording medium,
the slider having a negative-pressure cavity which is defined by a recess formed in the facing surface and generates a negative pressure, a leading step portion which protrudes from the facing surface, is situated on an upstream side of the negative-pressure cavity with respect to the airflow, and faces the recording medium, a trailing step portion which protrudes from the facing surface, is situated on a downstream side of the negative-pressure cavity with respect to the airflow, and faces the recording medium, and a trailing pad which protrudes from the trailing step portion,
the facing surface of the slider having a first direction extending in the direction of the airflow and a second direction perpendicular to the first direction,
the trailing pad having a base portion provided on the trailing step portion and situated on the outflow end side of the slider, a pair of wing portions extending from the base portion to opposite sides in the second direction, and two extending portions which individually extend from the base portion to the upstream side of the airflow and define a recess which opens toward the negative-pressure cavity.

2. The head according to claim 1, wherein the two extending portions individually extend in the first direction, each of the extending portions has a pair of side edge portions extending in the first direction, and the recess is defined by the side edge portions of the extending portions and a side edge portion of the base portion extending in the second direction.

3. The head according to claim 1, wherein a length of the side edge portions of the extending portions in the first direction accounts for 10% or more of a length of the slider in the first direction.

4. The head according to claim 1, wherein a space between the two extending portions in the second direction accounts for 10% or more of a width of the slider in the second direction.

5. The head according to claim 1, wherein respective lengths of the two extending portions in the first direction are equal to each other.

6. The head according to claim 1, wherein respective lengths of the two extending portions in the first direction are different from each other.

7. The head according to claim 1, wherein the slider has a pair of side portions which individually extend from the leading step portion toward a downstream end of the slider and protrude from the facing surface so as to surround the negative-pressure cavity.

8. The head according to claim 1, wherein a length of the slider in the first direction is 1.25 mm or less, and a width of the slider in the second direction is 0.7 mm or less.

9. A head suspension assembly used in a disk device which includes a disk-shaped recording medium and a drive section which supports and rotates the recording medium, the head suspension assembly comprising:
a head which includes a slider which has a facing surface opposed to a surface of the recording medium and is flown by an airflow which is generated between the recording medium surface and the facing surface as the recording medium rotates and a head portion which is disposed on the slider and records and reproduces information to and from the recording medium; and
a head suspension which supports the head for movement with respect to the recording medium and applies a head load directed to a surface of the recording medium to the head,
the slider having a negative-pressure cavity which is defined by a recess formed in the facing surface and generates a negative pressure, a leading step portion which protrudes from the facing surface, is situated on an upstream side of the negative-pressure cavity with respect to the airflow, and faces the recording medium, a trailing step portion which protrudes from the facing surface, is situated on a downstream side of the negative-pressure cavity with respect to the airflow, and faces the recording medium, and a trailing pad which protrudes from the trailing step portion, the facing surface of the slider having a first direction extending in the direction of the airflow and a second direction perpendicular to the first direction,
the trailing pad having a base portion provided on the trailing step portion and situated on the outflow end side of the slider, a pair of wing portions extending from the base portion to opposite sides in the second direction, and two extending portions which individually extend from the base portion to the upstream side of the airflow and define a recess which opens toward the negative-pressure cavity.

10. The head suspension assembly according to claim 9, wherein each of the extending portions has a pair of side edge portions extending in the first direction, and a length of the side edge portions of the extending portions in the first direction accounts for 10% or more of a length of the slider in the first direction.

11. A disk device comprising:
a disk-shaped recording medium;
a drive section which supports and rotates the recording medium;
a head which includes a slider which has a facing surface opposed to a surface of the recording medium and is flown by an airflow which is generated between the recording medium surface and the facing surface as the recording medium rotates and a head portion which is disposed on the slider and records and reproduces information to and from the recording medium; and
a head suspension which supports the head for movement with respect to the recording medium and applies a head load directed to a surface of the recording medium to the head,
the slider having a negative-pressure cavity which is defined by a recess formed in the facing surface and generates a negative pressure, a leading step portion which protrudes from the facing surface, is situated on an upstream side of the negative-pressure cavity with respect to the airflow, and faces the recording medium, a trailing step portion which protrudes from the facing surface, is situated on a downstream side of the negative-pressure cavity with respect to the airflow, and faces the recording medium, and a trailing pad which protrudes from the trailing step portion, the facing surface of the slider having a first direction extending in the direction of the airflow and a second direction perpendicular to the first direction,
the trailing pad having a base portion provided on the trailing step portion and situated on the outflow end side of the slider, a pair of wing portions extending from the base portion to opposite sides in the second direction, and two extending portions which individually extend from the base portion to the upstream side of the airflow and define a recess which opens toward the negative-pressure cavity.

12. The disk device according to claim 11, wherein each of the extending portions has a pair of side edge portions extending in the first direction, and a length of the side edge portions of the extending portions in the first direction accounts for 10% or more of a length of the slider in the first direction.
